(19) United States
(12) Patent Application Publication
(10) Pub. No.: US 2014/0272480 A1
(43) Pub. Date: Sep. 18, 2014

(54) CONDUCTOR FOR AN ELECTROCHEMICAL ENERGY STORE

(71) Applicants: Peter SCHUETZBACH, Moeglingen (DE); Armin GLOCK, Urbach (DE)

(72) Inventors: Peter SCHUETZBACH, Moeglingen (DE); Armin GLOCK, Urbach (DE)

(73) Assignee: ROBERT BOSCH GMBH, Stuttgart (DE)

(21) Appl. No.: 14/206,803

(22) Filed: Mar. 12, 2014

(30) Foreign Application Priority Data
Mar. 12, 2013 (DE) 10 2013 204 226.4

(51) Int. Cl. H01M 4/70; H01M 4/04; H01B 1/16

(52) U.S. Cl. CPC H01M 4/70; H01B 1/16; H01M 4/0402
USPC 429/50; 174/126.4; 429/211; 29/623.5

(57) ABSTRACT

A conductor is describing for an electrochemical energy store, including a base body, and at least one electrically conductive layer situated at least partially on the base body. The base body includes a non-electrically conductive material. In addition, an energy store is described which is equipped with the conductor, a method for manufacturing a conductor is described, and the use of the energy store equipped with the conductor in an electrical device is described.

### CROSS REFERENCE

The present application claims the benefit under 35 U.S.C. §119 of German Patent Application No. DE 10 2013 204 226.4 filed on Mar. 12, 2013, which is expressly incorporated herein by reference in its entirety.

### FIELD

The present invention relates to a conductor for an electrochemical energy store, an energy store equipped therewith, a method for manufacturing the conductor and the use of the energy store equipped with the conductor in an electronic component.

### BACKGROUND INFORMATION

In electrochemical energy stores, for example, lithium ion batteries, solid metal bodies in particular, such as metal foils made, for example, of copper or aluminum are used as both carrier and as conductor material.

Moreover, in the manufacture of such energy stores, for example, in the form of a wound cell, both sides of these solid metal bodies are coated, for example, either with anode material or with cathode material. During manufacture of the energy store, corresponding separators are used to prevent a direct contact between the anode material and the cathode material.

### SUMMARY

The present invention relates to a conductor for an electrochemical energy store.

An example conductor, in particular, current conductor for an electrochemical energy store, may include a base body, and at least one electrically conductive layer situated at least partially on the base body, the base body optionally including a non-electrically conductive material. The base body in this case may have a very thin structure of a non-electrically conductive material. The conductor, in particular, current conductor, may be connected to the electrode of the energy store and/or may be part of the electrode of the energy store, and may be used to tap the energy from the energy store. The electrically conductive layer in the present invention may be applied completely or at least partially to the base body. Within the scope of the present invention, the non-electrically conductive material may in such a case have an electrical conductivity less than or equal to 1*10⁻⁷ S/m. At the same time, the electrically conductive layer may have an electrical conductivity greater than or equal to 1*10⁵ S/m, particularly preferably greater than or equal to 1*10⁶ S/m. In the present invention the use of metal may be reduced by substituting a solid metal body with a base body having at least one electrically conductive layer situated on the base body, as a result of which the overall weight of the conductor may be reduced. Moreover, due to the generally more cost-effective base body, manufacturing costs may be lowered. As a result of the reduced weight, the use of a non-electrically conductive base body may also improve the ecobalance of the energy store, since less energy is required to manufacture the base body and the lighter weight may result in reduced transport costs.

Due to the electrically conductive layer, the conductor may carry out the function of conducting electric current, as a result of which the conductor having a non-electrically conductive base body may have the same functionality with regard to current conductivity as a conventional conductor. With the aid of the base body and the at least one electrically conductive layer, it is possible to manufacture thinner conductors than is the case when using conductors made from a solid metal body. As a result, the energy stores equipped with the conductor of the present invention may be reduced in size, thereby allowing for a reduction in the overall weight and size of the electrical devices which are equipped with the energy store.

The base body may advantageously have a density of less than or equal to 2.7 g/cm³, particularly preferably a density of less than or equal to 1.6 g/cm³, in particular a density of less than or equal to 1.1 g/cm³. Such densities are less than the density of metals which are used for conventional conductors. The use of a base body having such a density may advantageously further reduce the overall weight of the conductor.

The base body may advantageously include a plastic or may be made of a plastic which may be formed from or include the group composed of polymers, thermoplasts, polyamide, polyethylene and/or polypropylene. The use of a plastic may particularly advantageously reduce the overall weight of the conductor. In particular, when using such plastics the manufacturing costs may be advantageously further reduced due to the more cost-effective material of the base body. As a result of the lower weight, the use of the non-electrically conductive base body may also further improve the ecobalance of the energy store, since less energy is required to manufacture the base body and the lighter weight may result in reduced transport costs. Moreover, when using the conductor in an energy store, the plastic is stable and reliable during operation of the energy store.

In one advantageous specific embodiment, at least one electrically conductive layer situated at least partially on the base body may include a metal, in particular from the group composed of aluminum, copper, nickel, gold, stainless steel or of a metal alloy of the aforementioned metals. The metals used may be low in weight. When using the conductor in an energy store, the at least one electrically conductive layer may, as a result of the metal, be stable and may have good conductivity during operation of the energy store. In this way, the conductor may particularly preferably carry out the function of conducting electric current, whereby the conductor having a non-electrically conductive base body is not restricted in terms of functionality as compared to a conventional conductor. In this specific embodiment, the base body may either include only one electrically conductive layer situated at least partially on the base body, which includes a metal, or the base body may include multiple electrically conductive layers situated at least partially on the base body, whereby the multiple layers each may either include the same metal or the multiple layers each may include different metals.

It may be advantageous if the base body has a foil-like design. The term foil-like in this case may mean that the base body may be designed as a foil, whereby the foil may have a plane extension, and thus, in terms of length and width, the base body may have a flat extended surface and a small thickness. In this case, the foil may have flexible or deformable properties. In this way, conductors may also be advantageously provided which otherwise, given the workability of presently known manufacturing techniques, could be manufactured from a solid metal body only with great difficulty or not at all.

In one preferred specific embodiment, a first electrically conductive layer may be provided on one first side of the base body, and a second electrically conductive layer may be situated on one second side situated opposite the first side, whereby a first active material may be situated on the first conductive layer and a second active material may be situated on the second conductive layer. For example, the first electrically conductive layer may include copper and the second electrically conductive layer may include aluminum, and the first active material may include an anode material and the second active material may include a cathode material. Thus, the conductor may easily include a base body to which may be applied both an anode including, for example, the first electrically conductive layer and the first active material, as well as a cathode including, for example, the second electrically conductive layer and the second active material. The conductor may thus function as a combination electrode. The term combination electrode may indicate in this case that, for example, the anode may be situated on the first side of the base body of the conductor while at the same time the cathode, for example, may be situated on the second side of the base body of the conductor. In this configuration, the first active material may include an anode material which, for example, is selectable from a group composed of graphite, silicon, and/or titanate Li₄Ti₅O₁₂, and the second active material may include a cathode material which, for example, is selectable from a group composed of lithium metal oxide LiMeO such as LiNiₓCo_{y}Mn₂O₂, LiNiₓCo_{y}Al_{z}O₂, LiCoO₂, LiNiO₂, LiMn₂O₄ and/or LiFePO₄. It is also possible that the second active material may be formed from or to have a non-oxidic material or may include a non-oxidic material. In this way, a conductor for an energy store may be easily provided which provides both the anode and the cathode on a base body, whereby due to the configuration of the conductor, working steps and materials may be saved. This may result in additional advantageous savings in labor and costs.

Advantageously, the first conductive layer and the first active material may be situated on the first side of the base body and/or on the second side of the base body. Additionally, the second conductive layer and the second active material may alternatively be situated on the first side of the base body and/or on the second side of the base body. Situated on the first and/or second side of the base body may either be no material, the first conductive layer and the first active material and/or the second conductive layer and the second active material. In that way, the base body may be provided with the first conductive layer and the first active material on one side or on both sides, or provided with the second conductive layer and the second active material, or provided on one side with the first conductive layer and the first active material and on the other side with the second conductive layer and the second active material, thereby allowing the base body to be used as a single electrode or as a combination electrode. In this way, the present invention may be used to manufacture different electrodes. For example, conductors of various types may be manufactured on the same production machine.

With regard to further features and advantages of the example conductor according to the present invention, explicit reference is made to the explanations in connection with the energy store according to the present invention, the example method according to the present invention for manufacturing a conductor and the use according to the present invention of the energy store equipped with the conductor in an electrical device, and to the figures.

The present invention further relates to an electrochemical energy store, in particular a lithium ion battery having at least one previously described conductor. By using the previously described conductor in the energy store, it is possible to reduce the overall weight of the energy store. The size of the energy store may also be reduced, thereby simplifying transport and storage. Furthermore, the manufacture of the energy store may also be simplified as a result of the simplified conductor.

It may be advantageous if the energy store is designed as a stacked cell, in particular as a coffee bag cell or pouch cell, as a prismatic cell, or as a cylindrical cell, in particular a flat wound cell. The term stacked cell in this case may describe an energy store in which the energy cells may be stacked one on top of the other and are also called coffee bag cells or pouch cells. The stacked cells may, for example, have a rectangular or trapezoidal shape. The term prismatic cell in this case may describe an energy cell having square cells, whereby the electrodes may have a flat wound anode-separator-cathode assembly. The term cylindrical cell may describe an energy store having band-shaped electrodes. Here, the electrodes, due to their flat and foil-like design, may have the form of a flat band. The electrodes may be coiled into a winding, whereby at least one separator may be situated in the energy store during winding. The winding in the cylindrical cells is wound cylindrically and not as flat as in the case of a flat wound cell. It is also possible for the energy store to be manufactured using a Z-folding method. In the Z-folding method the electrodes are folded, unlike a prismatic cell. The term separator in this case may describe a layer between the cathode and the anode, which has the task of spatially and electrically separating the cathode and the anode, i.e., the negative and positive electrode in the energy store. The separator must be permeable to the ions, however, which cause the conversion of the stored chemical energy into electrical energy. The separator is ion-conductive in order to enable a process in the energy conductor to proceed. Primarily macroporous plastics as well as non-wovens made of glass fibers or polyethylene or compound foils, for example, made of polyethylene and propylene or ceramic materials may be used as materials for the separator. This allows the energy store to be manufactured in a variety of ways, as a result of which the energy store according to the present invention may be used in a variety of fields. In addition, the energy store may readily have at least two electrodes in order to deliver electrical energy to an electrical device.

Advantageously, the conductor of the energy store may have a first electrically conductive layer on a first side of the base body and a second electrically conductive layer may be situated on a second side opposite the first side, whereby a first active material may be situated on the first conductive layer, and a second active material may be situated on the second conductive layer, whereby the energy store may be designed as a prismatic cell or as a cylindrical cell, and the energy store may have a separator for separating the first active material from the second active material of the conductor, whereby the separator may be situated between the different layers of the conductor. For example, the first electrically conductive layer may include copper and the second electrically conductive layer may include aluminum, and the first active material may include an anode material and the second active material may include a cathode material. As a result, this may simplify the production of the energy store since, for example, joining of the webs, positioning of the webs, web tensioning and winding may be simplified. The term webs in this case may describe both the conductor and the separator, which have been produced as foils and may be wound together in order to produce the energy store in the form of a prismatic cell or cylindrical cell. The manufacturing and equipment technology may also be simplified, thereby saving on costs.

With regard to further features and advantages of the energy store according to the present invention, explicit reference is made to the explanations in connection with the conductor according to the present invention, the method according to the present invention for manufacturing a conductor and the use according to the present invention of the energy store equipped with the conductor in an electrical device, and to the figures.

The present invention also relates to an example method for manufacturing a conductor for an electrochemical energy store, whereby the conductor may have a base body and at least one electrically conductive layer situated at least partially on the base body, and including at least the following steps: providing the base body, whereby the base body may include a non-electrically conductive material, and applying at least one electrically conductive layer at least partially to the base body. Using this method it is possible to easily manufacture a conductor according to the present invention. With the aid of this example method, it is possible to omit the use of a solid metal body when manufacturing the conductor, as a result of which the weight of the conductor and material costs and manufacturing costs of the conductor may be reduced. In addition, thinner conductors may be manufactured by using the method which otherwise could not be manufactured using a solid metal body given the presently known manufacturing techniques. Furthermore, use of the conductor manufactured using the method may also improve the ecobalance of the product in which the conductor is used, since a lighter weight may reduce transport costs and the energy consumption of the product.

It may be advantageous if in the example method an active material is applied at least partially to at least one conductive layer. For example, the electrically conductive layer situated on the base body may include a metal, copper, for example, and applied to the copper may be an active material, for example, selected from a group composed of graphite, silicon and/or titanate Li₄Ti₅O₁₂, so that, for example, the electrically conductive layer and the active material form an anode. Furthermore, a second conductive layer, for example, a metal, in particular aluminum, may be situated on a second side of the base body, the second side being situated opposite the first side, and a second active material, selected for example from a group consisting of lithium metal oxide LiMeO such as LiNiₓCo_{y}Mn_{z}O₂, LiNiₓCoᵣAl_{z}O₂, LiCoO₂, LiNiO₂, LiMn₂O₄ or LiFePO₄ may be situated on the second conductive layer so that, for example, the second electrically conductive layer and the second active material form a cathode. In this way the conductor may be advantageously designed as a combination electrode, making it advantageously possible to save on material costs and also on installation space in the energy store. In addition, production of the conductor in conjunction with the method according to the present invention may be further simplified, resulting in further reduced manufacturing costs.

It may be advantageous if in the method at least one electrically conductive layer is applied to the base body by coating, laminating or printing. The different forms of application make it possible to adapt the manufacturing process of the conductor to existing manufacturing techniques and equipment. This may make it unnecessary to purchase new equipment. In addition, an active material may be at least partially applied to the at least one electrically conductive layer in the same manner as the electrically conductive layer. Thus, in this method it may be possible for an anode, for example, in the form of the first electrically conductive layer and the first active material situated thereon to be formed on the first side of the base body of the conductor, and on the second side of the base body a cathode in the form of the second electrically conductive layer and the second active material situated thereon. For example, in this method the base body may be present as a metalized foil in the form of a coil, which is unrolled and, with the aid of a coating/drying facility, the surface of which is coated with an active material. The metalized foil may include a plastic foil which may be metalized with a metal, for example, by sputtering, of a chemical or electrochemical coating. In this way, the conductor may be designed as a combination electrode, whereby, for example, material, labor costs, storage costs, weight and manufacturing costs of the electrochemical energy store may be further reduced.

With regard to further features and advantages of the method according to the present invention, explicit reference is made to the explanations in connection with the conductor according to the present invention, the energy store according to the present invention and the use according to the present invention of the energy store equipped with the conductor in an electrical device, and to the figures.

The present invention further relates to the use of the electrochemical energy store having at least one previously described conductor in motor vehicle applications, other electromobilities, in particular in ships, two-wheelers, aircraft, stationary energy stores, power tools, consumer electronics and/or household electronics. The term other electromobilities describes in this case any type of vehicle and means of transportation which are capable of using the chemically generated electrical energy of the energy store. The motor vehicle applications, other electromobilities, in particular ships, two-wheelers, aircraft, stationary energy stores, power tools, consumer electronics and/or household electronics may in this case constitute electronic components which are capable of using the chemically generated electrical energy of the energy store. The weight of the electronic components may be reduced in this way, as a result of which symptoms of fatigue on the part of the user may be reduced when using the electronic components. Furthermore, use of the energy store may either increase the energy performance, since the weight saved may be used for higher energy performance of the energy store, and/or less energy is required in order to transport the electronic components. In addition, the conductor may be cost-effectively integrated into the energy store, thereby making a simpler configuration of the energy store possible, thereby facilitating the installation in the electronic components when using the electronic store.

With regard to further features and advantages of the use according to the present invention, explicit reference is made to the explanations in connection with the conductor according to the present invention, the energy store according to the present invention and the method according to the present invention for manufacturing an energy store, and to the figures.

### BRIEF DESCRIPTION OF THE DRAWINGS

Further advantages and advantageous embodiments of the present invention are demonstrated in the figures and explained in greater detail below. It is to be noted that the figures and examples are only of descriptive character and are not intended to restrict the present invention in any form.

FIG. 1 schematically shows a view of a section of a conductor having an electrically conductive layer situated on one side of the base body and an active material according to one specific embodiment of the present invention.

FIG. 2 schematically shows a view of a section of a conductor having a base body on which an electrically conductive layer and an active material are situated on both sides of the base body according to one specific embodiment of the present invention.

FIG. 3 schematically shows a view of a cylindrical cell having a conductor according to one specific embodiment of the present invention.

FIG. 4 schematically shows an isometric view of a section of the cylindrical cell of FIG. 3.

### DETAILED DESCRIPTION OF EXAMPLE EMBODIMENTS

FIG. 1 shows a conductor 10 for an electrochemical energy store 30. The conductor includes a base body 12 and at least one electrically conductive layer 18 situated at least partially on base body 12. In this exemplary embodiment base body 12 includes a polymer. The polymer in this example has a density of less than or equal to 2.7 g/cm³. Electrically conductive layer 18 situated at least partially on base body 12 includes a metal; in this exemplary embodiment it is copper.

Although not shown in FIG. 1, base body 12 of conductor 10 has a foil-like design, base body 12 having a plane extension. The foil-like configuration of base body 12 and the resultant plane extension are shown in FIG. 4.

In FIG. 1, base body 10 includes a first side 14 on its plane extension and a second side 16 situated opposite first side 14.

As is apparent in FIG. 1, a first conductive layer 18 is situated on first side 14 of base body 12. First electrically conductive layer 18 includes at least partially a first active material 22. In this specific exemplary embodiment first active material 22 is an anode material in the form of graphite. An anode 32 is thus formed by first electrically conductive layer 18 situated on first side 14 of base body 12 and by first active material 22 situated on first electrically conductive layer 18.

In FIG. 2, a conductor 10 is shown which is designed as a combination electrode. Base body 12 is intended to be designed as a foil, as shown in FIG. 4.

In FIG. 2, a first electrically conductive layer 18 is formed on conductor 10 on a first side 14 of base body 12. Situated on a second side 16 situated opposite first side 14 is a second electrically conductive layer 20. As is apparent in FIG. 2, a first active material 22 is situated on first conductive layer 18, and a second active material 24 is situated on second conductive layer 20. In this exemplary embodiment, first electrically conductive layer 18 includes copper and second electrically conductive layer 20 includes aluminum. First active material 22 in this case includes an anode material, such as graphite and second active material 24 includes a cathode material in the form of a lithium metal oxide, such as LiCoO₂. An anode 32 is thus formed on first side 14 of base body 12 which includes first electrically conductive layer 18 and first active material 22. Furthermore, a cathode 34 is formed on second side 16 of base body 12, which includes second electrically conductive layer 20 and second active material 24.

FIG. 3 schematically shows a view of an electrochemical energy store 30. In this exemplary embodiment energy store 30 is a lithium ion battery. Energy store 30 is represented as a cylindrical cell and includes a conductor 10, which is designed as a combination electrode according to FIG. 2. Thus, energy store 30 includes conductor 10, conductor 10 including a cathode 34 and an anode 32, and a separator 26.

FIG. 3 is merely a schematic view, so that other main components of energy store 30, for example, housing or electrolyte, are not shown.

The configuration of conductor 10 in energy store 30 of FIG. 3 is intended to be identical to the configuration of conductor 10 in FIG. 2, a section of the cylindrical cell is shown in FIG. 4. Energy store 30 includes conductor 10. Conductor 10 includes a base body 12 and situated on a first side 14 of base body 12 is a first electrically conductive layer 18. Situated on a second side 16 of base body 12 situated opposite first side 14 is a second electrically conductive layer 20. Situated on first electrically conductive layer 18 is a first active material 22, and situated on second conductive layer 20 is a second active material 24. In this exemplary embodiment, first electrically conductive layer 18 includes copper, and second electrically conductive layer 20 includes aluminum. In addition, first active material 22 includes an anode material, such as graphite, and second active material 24 includes a cathode material in the form of lithium metal oxide, such as LiCoO₂. Energy store 30 in the form of a cylindrical cell includes a separator 26 for the winding for separating first active material 22 from second active material 24 of conductor 10, separator 26 being situated between the different layers of conductor 10. Separator 26 in this case has a compound foil including polyethylene and polypropylene.

Energy store 30 may also be designed as a stacked cell, a prismatic cell, or as a flat wound cell. This is not shown, however.

Such conductors 10 for an electrochemical energy store 30 have a base body 12 and at least one conductive layer 18, 20 situated on one side 14, 16 of base body 12, and may be manufactured using a method which includes at least the following steps: providing base body 12, base body 12 having a non-electrically conductive material, and applying at least one conductive layer 18, 20 at least partially to the base body. In this exemplary embodiment, the material of base body 12 is a polymer. In the method, conductive layer 18, 20 situated on base body 12 includes at least one metal and is applied to base body 12.

In this exemplary embodiment, application takes place by coating. It is also possible in this method for a first conductive layer 18, such as a copper layer, to first be applied to a first side 14 of base body 12. Subsequently, at least first conductive layer 18 is at partially coated with a first active material 22, such as graphite. Applied to a second side 16 of base body 12, first side 14 of base body 12 being situated opposite second side 16, is a second conductive layer 20, such as an aluminum layer. Subsequently, a second conductive layer 20 is at least partially coated with a second active material 24, such as LiCoO₂. In this way a conductor 10 may be easily manufactured which includes on one side an anode 32 which includes copper and graphite, and on the other side a cathode 34 which includes aluminum and LiCoO₂.

In addition to coating, the at least one electrically conductive layer 18, 20 in this method may also be applied to the base body 12 by laminating or printing.

The above described conductor 10 may be used in an energy store 30. Energy store 30 may be used in other electromobilities, in particular in ships, two-wheelers, aircraft and similar stationary energy stores, power tools, consumer electronics and/or household electronics.

What is claimed is:

1. A conductor for an electrochemical energy store, comprising:
a base body, the base body including a non-electrically conductive material; and
at least one electrically conductive layer situated at least partially on the base body.

2. The conductor as recited in claim 1, wherein the base body has a density of less than or equal to 2.7 g/cm³.

3. The conductor as recited in claim 1, wherein the base body has a density of less than or equal to 1.6 g/cm³.

4. The conductor as recited in claim 1, wherein the base body has a density of less than or equal to 1.1 g/cm³.

5. The conductor as recited in claim 1, wherein the base body includes a plastic which is selected from a group composed of polymers, thermoplasts, polyamide, polyethylene, and polypropylene.

6. The conductor as recited in claim 1, wherein at least one of the electrically conductive layers includes a metal selected from a group composed of aluminum, copper, nickel, gold, stainless steel or of a metal alloy of one of aluminum, copper, nickel, gold, or stainless steel.

7. The conductor as recited in claim 1, wherein the base body has a foil-like design.

8. The conductor as recited in claim 1, wherein a first one of the electrically conductive layers is provided on a first side of the base body, and a second one of the electrically conductive layers being situated on a second side situated opposite the first side, and wherein at least one of a first active material is situated on the first conductive layer, and a second active material is situated on the second conductive layer.

9. A lithium ion battery, comprising:
at least one conductor including a base body, the base body including a non-electrically conductive material, and at least one electrically conductive layer situated at least partially on the base body.

10. The lithium ion battery as recited in claim 9, wherein the energy store is designed as one of a stacked cell, a prismatic cell or a cylindrical cell.

11. The lithium ion battery as recited in claim 9, wherein the conductor includes a first electrically conductive layer on a first side of the base body, a second electrically conductive layer situated on a second side situated opposite the first side, a first active material situated on the first conductive layer, and a second active material situated on the second conductive layer, wherein the energy store designed as a prismatic cell or cylindrical cell, the energy store includes a separator to separate the first active material from the second active material of the conductor, the separator being situated between the different layers of the conductor.

12. A method for manufacturing a conductor for an electrochemical energy store, wherein the conductor includes a base body and at least one electrically conductive layer situated at least partially on the base body, the method comprising:
providing the base body, the base body including a non-electrically conductive material; and
applying at least one electrically conductive layer at least partially to the base body.

13. The method as recited in claim 12, wherein an active material is applied at least partially to at least one of the electrically conductive layers.

14. The method as recited in claim 12, wherein at least one of the electrically conductive layers is applied to the base body by one of coating, laminating or printing.

15. A method, comprising:
providing an electrochemical energy store including at least one conductor including a base body, the base body including a non-electrically conductive material, and at least one electrically conductive layer situated at least partially on the base body; and
using the electrochemical energy store in at least one of a motor vehicle application, a power tool, consumer electronics, and household electronics.
